(19) United States
(12) Patent Application Publication
(10) Pub. No.: US 2006/0022995 A1
(43) Pub. Date: Feb. 2, 2006

(54) Method for reducing noise in digital images

(76) Inventor: Yi-Pin Chang, Taipei City (TW)

Correspondence Address: Raymond Sun, 12420 Woodhall Way, Tustin, CA, 92782, US

(21) Appl. No.: 10/903,580

(22) Filed: Jul. 30, 2004

(51) Int. Cl. G09G 5/02

(52) U.S. Cl. 345/600

(57) ABSTRACT

A method for cleaning the noise in an image obtains an image having an interested pixel and a predetermined number of neighboring pixels for each of red, green and blue, then calculates an adjusted value for the interested pixel based on the existing value of the interested pixel and the values of the predetermined number of neighboring pixels. This calculation is carried out for each of red, green and blue using the same predetermined number of neighboring pixels.

### BACKGROUND OF THE INVENTION

1. Field of the Invention

The present invention relates to the processing of digital images, and in particular, to a method for reducing noise in digital images.

2. Description of the Prior Art

Digital cameras have become very popular in recent times. The images captured by these digital cameras must be processed before they can be printed. The processing usually involves at least the following steps.

First, the image is captured by a sensor, such as a charge-coupled device (CCD). The captured image is then “denoised” (i.e., cleaning the noise), where undesirable noise is removed. The denoised image then undergoes interpolation before going through image processing. After image processing, compression is applied to the image before the resultant image is displayed or stored (e.g., in a memory).

The noise cleaning step is very important because noise in the captured image can significantly degrade the quality of the resultant images. For example, any amplification of the color values in an image will also amplify the noise in the image. As a result, the most effective time to reduce noise and its impact is to perform noise cleaning immediatedly after the image has been captured, but before interpolation.

Using Bajer pattern arrangements, there are usually 13 green pixels in a 5×5 block of pixels, 9 red pixels in a 5×5 block of pixels, and 9 blue pixels in a 5×5 block of pixels.

One example of a conventional noise cleaning method is illustrated in FIGS. 1A-3D. First, FIGS. 1A-1C illustrate the Red, Green and Blue channels, respectively, of a conventional Sigma filter. According to this conventional method, pixels are classified as either larger-than-threshold (LTT) or smaller-than-threshold (STT). Specifically, pixels with differences that are larger than a pre-defined threshold are considered to be LTT pixels, while pixels with differences that are smaller than a pre-defined threshold are considered to be STT pixels.

FIGS. 2A-2D illustrate an example of how this conventional method performs noise cleaning on the 13 green color pixels in an image. Assuming a pre-defined threshold of 10, FIG. 2A illustrates the values of the 13 green pixels, with the value of Gc being 20. In the first step, the adjacent 12 pixels are classified as either LTT or STT. In this regard, FIG. 2B shows the differences between the value of each pixel and the value of Gc. Next, as shown in FIG. 2C, the LLT pixels are excluded and the STT pixels are retained. Finally, the method calculates the average value of all the retained pixels from FIG. 2C (i.e., the STT pixels and Gc), and replaces the original value of Gc (i.e., 20) with the calculated average value (i.e., 21). See FIG. 2D.

FIGS. 3A-3D illustrate an example of how this conventional method performs noise cleaning on the 9 red color pixels in an image. Again assuming a pre-defined threshold of 10, FIG. 3A illustrates the values of the 9 red pixels, with the value of Rc being 28. In the first step, the adjacent 8 pixels are classified as either LTT or STT. In this regard, FIG. 3B shows the differences between the value of each pixel and the value of Rc. Next, as shown in FIG. 3C, the LLT pixels are excluded and the STT pixels are retained. Finally, the method calculates the average value of all the retained pixels from FIG. 3C (i.e., the STT pixels and Rc), and replaces the original value of Rc (i.e., 28) with the calculated average value (i.e., 25). See FIG. 3D. The same process shown in FIGS. 3A-3D can be used for both the nine red color pixels and nine blue color pixels.

Unfortunately, this conventional method suffers from a serious drawback in that the number of retained pixels is not constant during image processing. This makes hardware implementation very complex and expensive. In addition, the determination of the number of retained pixels can be very time-consuming.

Thus, there remains a need for an improved method of cleaning noise in a captured image which overcomes the drawbacks set forth above.

### SUMMARY OF THE DISCLOSURE

It is an object of the present invention to provide an improved method of cleaning noise in a captured image.

It is another object of the present invention to provide a method of cleaning noise in a captured image that is adaptive to the image content.

It is yet another object of the present invention to provide a method of cleaning noise in a captured image that is simple and easy to implement.

In order to accomplish the objects of the present invention, the present invention provides a method for cleaning the noise in an image. The method obtains an image having an interested pixel and a predetermined number of neighboring pixels for each of red, green and blue, then calculates an adjusted value for the interested pixel based on the existing value of the interested pixel and the values of the predetermined number of neighboring pixels. This calculation is carried out for each of red, green and blue using the same predetermined number of neighboring pixels.

### BRIEF DESCRIPTION OF THE DRAWINGS

FIGS. 1A-1C illustrate the R, G and B channels, respectively, of a conventional noise cleaning filter.

FIGS. 2A-2D illustrate an example of how the conventional method performs noise cleaning on the green color pixels in an image.

FIGS. 3A-3D illustrate an example of how the conventional method performs noise cleaning on the red color pixels in an image.

FIGS. 4A-4C illustrate the R, G and B channels, respectively, of a noise cleaning filter according to the present invention.

FIGS. 5A-5D illustrate an example of how the method of the present invention performs noise cleaning on the green color pixels in an image.

FIGS. 6A-6D illustrate an example of how the method of the present invention performs noise cleaning on the red color pixels in an image.

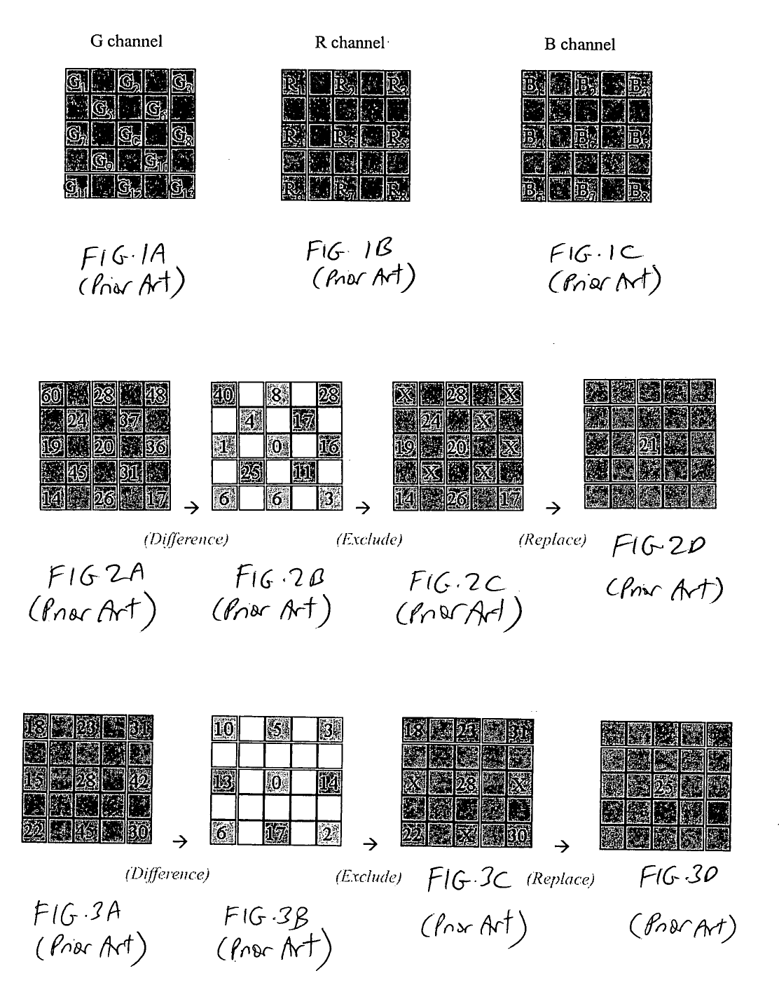

### DETAILED DESCRIPTION OF THE PREFERRED EMBODIMENTS

The following detailed description is of the best presently contemplated modes of carrying out the invention. This description is not to be taken in a limiting sense, but is made merely for the purpose of illustrating general principles of embodiments of the invention. The scope of the invention is best defined by the appended claims.

The present invention provides a noise cleaning method where the number of retained pixels are maintained constant during image processing under this method. This simplifies the hardware implementation, and increases the speed of the noise cleaning.

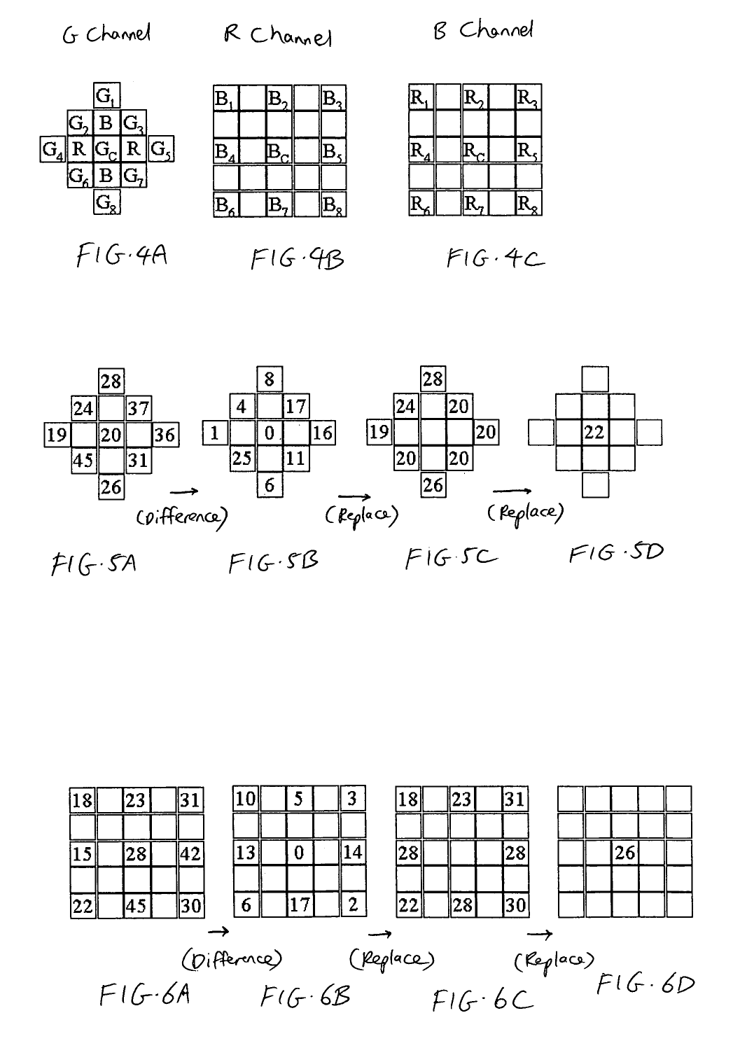

FIGS. 4A-4C illustrate the Red, Green and Blue channels, respectively, of a de-noise filter according to the present invention. According to this method, pixels are classified as either larger-than-threshold (LTT) or smaller-than-threshold (STT). Specifically, pixels with differences that are larger than a pre-defined threshold are considered to be LTT pixels, while pixels with differences that are smaller than a pre-defined threshold are considered to be STT pixels.

In the present invention, nine green color pixels are selected so that the number of pixels being processed remains the same as for the red and blue color pixels. As a result, there are eight (i.e., 2³) neighboring pixels to the interested pixel Gc, Rc or Bc. The nine selected green color pixels exclude the four corner green color pixels of the image, which are furthest away from the interested pixel Gc.

FIGS. 5A-5D illustrate an example of how this method performs noise cleaning on nine selected green color pixels in an image. Assuming a pre-defined threshold of 10, FIG. 5A illustrates the values of the nine green pixels, with the value of Gc being 20. In the first step, the adjacent eight pixels are classified as either LTT or STT. In this regard, FIG. 5B shows the differences between the value of each pixel and the value of Gc. Next, as shown in FIG. 5C, the values of the LLT pixels are replaced with the value of Gc (i.e. 20), and the values of the STT pixels are retained. Finally, the method calculates the average value of all the pixels from FIG. 5C (including Gc), and replaces the original value of Gc (i.e., 20) with the calculated average value (i.e., 22). See FIG. 5D.

FIGS. 6A-6D illustrate an example of how this method performs noise cleaning on nine selected red color pixels in an image. Assuming a pre-defined threshold of 10, FIG. 6A illustrates the values of the nine red pixels, with the value of Rc being 28. In the first step, the adjacent eight pixels are classified as either LTT or STT. In this regard, FIG. 6B shows the differences between the value of each pixel and the value of Gc. Next, as shown in FIG. 6C, the values of the LLT pixels are replaced with the value of Rc (i.e. 28), and the values of the STT pixels are retained. Finally, the method calculates the average value of all the pixels from FIG. 6C (including Rc), and replaces the original value of Rc (i.e., 28) with the calculated average value (i.e., 26). See FIG. 6D. The same process shown in FIGS. 6A-6D can be used for both the nine red color pixels and nine blue color pixels.

Thus, the present invention provides improved noise-cleaning results by utilizing a constant number of neighboring pixels, thereby reducing computation time and hardware complexity because the calculation of the STT pixels is not needed.

In addition, the mask is selected so that the number of working pixels is 2^{N}, with N being any positive integer greater than 0. As a result, the divisors are 2, 4, 8, 16 . . . , so that multiplication operations can be easily performed by shifts in hardware.

While the description above refers to particular embodiments of the present invention, it will be understood that many modifications may be made without departing from the spirit thereof. The accompanying claims are intended to cover such modifications as would fall within the true scope and spirit of the present invention.

What is claimed is:

1. A method for cleaning the noise in an image, comprising:
a. obtaining an image having an interested pixel and a predetermined number of neighboring pixels;
b. defining a threshold;
c. obtaining the difference between the value of each neighboring pixel and the value of the interested pixel;
d. classifying each of the neighboring pixels as being larger than the threshold (LTT) or smaller than the threshold (STT) based on the differences calculated in step (c);
e. replacing the value of the LTT pixels with the value of the interested pixel, while retaining the values of the STT pixels;
f. calculating the average value of all the predetermined number of pixels obtained from step (e) and the interested pixel; and
g. replacing the original value of the interested pixel with the average value.

2. The method of claim 1, wherein steps (a)-(g) are performed for each of red, green and blue colors.

3. The method of claim 2, wherein the predetermined number of neighboring pixels is the same for red, green and blue.

4. The method of claim 2, wherein the predetermined number of neighboring pixels is nine for red, green and blue.

5. The method of claim 1, wherein the predetermined number of neighboring pixels is nine for green.

6. A method for cleaning the noise in an image:
a. obtaining an image having an interested pixel and a predetermined number of neighboring pixels for each of red, green and blue;
b. calculating an adjusted value for the interested pixel based on the existing value of the interested pixel and the values of the predetermined number of neighboring pixels; and
c. repeating step (b) for each of red, green and blue using the same predetermined number of neighboring pixels.
